(19) United States
(12) Patent Application Publication
(10) Pub. No.: US 2021/0387603 A1
(43) Pub. Date: Dec. 16, 2021

(54) ELECTRONIC CALIPER BRAKE AND OPERATION METHOD THEREOF

(71) Applicant: MANDO CORPORATION, Pyeongtaek (KR)

(72) Inventor: Jaejin Hur, Seongnam (KR)

(21) Appl. No.: 17/334,962

(22) Filed: May 31, 2021

(30) Foreign Application Priority Data
Jun. 10, 2020 (KR) 10-2020-0069997

(51) Int. Cl. B60T 13/58; B60T 1/06; B60T 13/66; B60T 13/74; F16D 55/226; F16D 65/18

(52) U.S. Cl. CPC B60T 13/588; B60T 1/065; B60T 13/66; F16D 2121/04; F16D 55/226; F16D 65/18; B60T 13/746

(57) ABSTRACT

Disclosed are an electronic caliper brake and an operation method thereof. The electronic caliper brake includes a carrier on which a pair of pad plates are installed to advance and retreat, a caliper housing slidably installed on the carrier and provided with a cylinder in which a piston is installed to advance and retreat by a braking hydraulic pressure, a hydraulic pressure supply device configured to supply the braking hydraulic pressure to the cylinder, a spindle member installed to penetrate through a rear portion of the cylinder and configured to rotate by receiving a rotational force of an actuator, a nut member configured to advance and retreat depending to the rotation of the spindle member to press and release the piston, and a power transmission device in which an input part is connected to an output shaft of the actuator and an output part is connected to the spindle member, and configured to transmit the rotational force of the actuator to the spindle member.

### CROSS-REFERENCE TO RELATED APPLICATION(S)

This application is based on and claims priority under 35 U.S.C. § 119 to Korean Patent Application No. 10-2020-0069997, filed on Jun. 10, 2020, in the Korean Intellectual Property Office, the disclosure of which is incorporated by reference herein in its entirety.

### BACKGROUND

### 1. Field

The disclosure relates to an electronic caliper brake and an operation method thereof, and more particularly, to an electronic caliper brake capable of disposing a caliper housing and an actuator to be separated or spaced apart from each other, and an operation method thereof.

### 2. Description of the Related Art

In general, an electronic caliper brake refers to an apparatus in which an actuator that is operated by electricity is employed in a caliper brake to which a braking force by hydraulic pressure is provided.

A typical electronic caliper brake includes a disk rotating together with a wheel of a vehicle, a carrier on which a pair of pad plates are mounted to advance and retreat so as to press the disk, a housing provided with a cylinder slidably mounted on the carrier and in which a piston is installed to advance and retreat by a hydraulic pressure of a braking fluid such as a brake oil, a spindle unit provided to press the piston, a motor and a reducer as an actuator that transmits a rotational force to the spindle unit, and the like.

This electronic caliper brake performs braking by pressing the piston using a hydraulic pressure of the braking fluid, or performs braking by converting a rotational force provided from the motor into a linear motion by a nut member and a spindle member of the spindle unit and by pressing the piston.

Specifically, in the case where braking is performed using a hydraulic pressure of the braking fluid, a braking fluid such as a brake oil is supplied to an empty space between the piston in the cylinder and a spindle, so that the piston is operated by pressing of the braking fluid. In the case where braking is performed by a rotational force of the motor, when power is applied to the motor, the spindle member rotates and the nut member advances and retreats to press the piston, so that a braking or parking function is performed.

Korean Patent Publication No. 10-2011-0124817 has been disclosed as an example of a conventional electronic caliper brake.

### SUMMARY

It is an aspect of the disclosure to provide an electronic caliper brake capable of disposing a caliper housing and an actuator to be separated or spaced apart from each other, and an operation method thereof.

It is an aspect of the disclosure to provide an electronic caliper brake capable of improving a braking feeling of a driver, and an operation method thereof.

It is an aspect of the disclosure to provide an electronic caliper brake capable of stably operating a spindle member and a nut member, and an operation method thereof.

Additional aspects of the disclosure will be set forth in part in the description which follows and, in part, will be obvious from the description, or may be learned by practice of the disclosure.

In accordance with an aspect of the disclosure, an electronic caliper brake includes a carrier on which a pair of pad plates are installed to advance and retreat, a caliper housing slidably installed on the carrier and provided with a cylinder in which a piston is installed to advance and retreat by a braking hydraulic pressure, a hydraulic pressure supply device configured to supply the braking hydraulic pressure to the cylinder, an actuator configured to provide a rotational force, a spindle member installed to penetrate through a rear portion of the cylinder and configured to rotate by receiving the rotational force of the actuator, a nut member configured to advance and retreat depending to the rotation of the spindle member to press and release the piston, and a power transmission device in which an input part is connected to an output shaft of the actuator and an output part is connected to the spindle member, and configured to transmit the rotational force of the actuator to the spindle member, wherein the output shaft of the actuator is disposed to be spaced apart from the spindle member.

The power transmission device may be provided as one of a flexible shaft and a universal joint.

The power transmission device may be provided as one of a rod shaft and a plurality of bevel gear shafts.

The spindle member may be disposed inside the cylinder of the caliper housing.

The actuator may be provided with a pair of the output shafts, a pair of the power transmission devices may be provided, and the input parts of the pair of power transmission devices may be connected to the pair of output shafts, respectively, and the output parts may be connected to the spindle members of the caliper housings provided on left and right wheels of a vehicle, respectively.

The actuator may be provided with a pair of the output shafts, a pair of the power transmission devices may be provided, and the input parts of the pair of power transmission devices may be connected to the pair of output shafts, respectively, and the output parts may be connected to the spindle members of the caliper housings provided on front and rear wheels of a vehicle, respectively.

The electronic caliper brake may further include an electronic control unit configured to control the operation of the hydraulic supply device and the actuator.

In accordance with an aspect of the disclosure, an electronic caliper brake includes a carrier on which a pair of pad plates are installed to advance and retreat, a caliper housing slidably installed on the carrier and provided with a cylinder in which a piston is installed to advance and retreat by a braking hydraulic pressure, a hydraulic pressure supply device configured to supply the braking hydraulic pressure to the cylinder, an actuator configured to provide a rotational force, a spindle member installed to penetrate through a rear portion of the cylinder and configured to rotate by receiving the rotational force of the actuator, a nut member configured to advance and retreat depending to the rotation of the spindle member to press and release the piston, and a power transmission device in which an input part is connected to an output shaft of the actuator and an output part is connected to the spindle member, and configured to transmit the rotational force of the actuator to the spindle member, wherein the power transmission device is provided to be flexible.

In accordance with an aspect of the disclosure, an electronic caliper brake includes a carrier on which a pair of pad plates are installed to advance and retreat, a caliper housing slidably installed on the carrier and provided with a cylinder in which a piston is installed to advance and retreat by a braking hydraulic pressure, a hydraulic pressure supply device configured to supply the braking hydraulic pressure to the cylinder, an actuator configured to provide a rotational force and including an actuator housing, a spindle member installed to penetrate through a rear portion of the cylinder and configured to rotate by receiving the rotational force of the actuator, a nut member configured to advance and retreat depending to the rotation of the spindle member to press and release the piston, and a power transmission device in which an input part is connected to an output shaft of the actuator and an output part is connected to the spindle member, and configured to transmit the rotational force of the actuator to the spindle member, wherein the caliper housing and the actuator housing are separately provided to be spaced apart from each other.

In accordance with an aspect of the disclosure, an operation method of the electronic caliper brake wherein in a first mode in which parking braking is performed, the electronic control unit controls a hydraulic supply device to generate a braking hydraulic pressure to advance a piston, a spindle member to rotate in a first direction by operating an actuator so that the piston is supported in an advanced position, and then a nut member to advance according to the rotation of the spindle member in the first direction to support the piston.

The electronic control unit may control the hydraulic pressure supply device such that the braking hydraulic pressure is released in a state in which the piston is supported by the nut member.

In a second mode in which release of the parking braking is performed, the electronic control unit may controls the hydraulic supply device to generate an additional braking hydraulic pressure so that a gap is formed between the piston and the nut member, the actuator to operate to rotate the spindle member in a second direction opposite to the first direction, and then the nut member to retreat according to the rotation of the spindle member in the second direction to be spaced apart from the piston.

The electronic control unit may control the hydraulic pressure supply device such that the braking hydraulic pressure is released in a state in which the nut member is spaced apart from the piston.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view of an electronic caliper brake according to an embodiment of the disclosure;

FIG. 2 is a perspective view of a power transmission device according to an embodiment of the disclosure; and

FIGS. 3 to 5 are views illustrating operating processes of an electronic caliper brake according to an embodiment of the disclosure.

### DETAILED DESCRIPTION

Hereinafter embodiments of the disclosure will be described in detail with reference to the accompanying drawings. The embodiments described below are provided by way of example so that those skilled in the art will be able to fully understand the spirit of the disclosure. The disclosure is not limited to the embodiments described below, but may be embodied in other forms. In order to clearly explain the disclosure, parts not related to the description are omitted from the drawings, and the width, length, thickness, etc. of the components may be exaggerated for convenience.

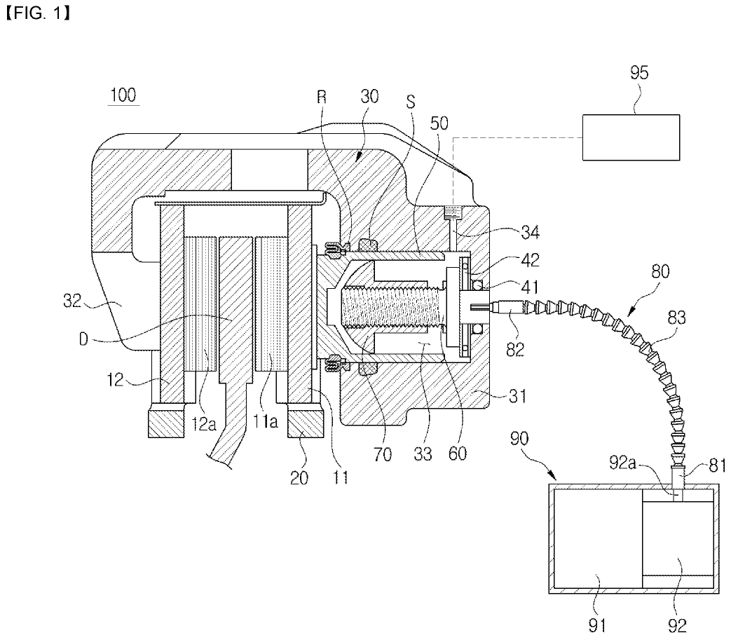

Referring to FIG. 1, an electronic caliper brake 100 according to an embodiment of the disclosure may include a carrier 20 in which a pair of pad plates 11 and 12 are installed to advance and retreat so as to press a disk D that rotates together with a wheel (not shown) of a vehicle, a caliper housing 30 provided with a cylinder 31 that is slidably installed on the carrier 20 and in which a piston 50 is installed so as to advance and retreat by a braking hydraulic pressure, a hydraulic pressure supply device 95 to supply the braking hydraulic pressure to the cylinder 31, a spindle member 60 installed to penetrate through a rear portion of the cylinder 31 and rotating by receiving a rotational force of an actuator 90, a nut member 70 to advance and retreat depending on the rotation of the spindle member 60 so as to press and release the piston 50, and a power transmission device 80 in which an input part 81 is connected to the actuator 90 and an output part 82 is connected to the spindle member 60 to transmit the rotational force of the actuator 90 to the spindle member 60.

The pair of pad plates 11 and 12 include the inner pad plate 11 disposed to be in contact with the piston 50, and the outer pad plate 12 disposed to be in contact with a finger part 32 of the caliper housing 30, which will be described later. The pair of pad plates 11 and 12 may be installed on the carrier 20 fixed to a vehicle body to advance and retreat toward opposite sides of the disk D. Friction pads 11a and 12a may be attached to one surfaces of the pad plates 11 and 12 facing the disk D, respectively. Reference numeral “R”, which is not described, refers to a boot R that is installed between an inlet of the cylinder 31 and the piston 50 to prevent foreign substances from entering between the cylinder 31 and the piston 50. The caliper housing 30 may be slidably installed on the carrier 20. The caliper housing 30 may be provided with the cylinder 31 and a hydraulic chamber 33 in which a braking fluid such as a brake oil is supplied therein and the piston 50 is accommodated to advance and retreat. The spindle member 60 and the nut member 70, which will be described later, may be installed on a rear side of the cylinder 31. The caliper housing 30 may be provided with the finger part 32 formed to be bent from the front to operate the outer pad plate 12. The cylinder 31 and the finger part 32 may be integrally formed, but the disclosure is not limited thereto.

The piston 50 may be formed in a hollow shape and may be provided to be slidable in the hydraulic chamber 33 in the cylinder 31. Specifically, the piston 50 may be provided in the shape of an empty cup to be in contact with the nut member 70, which will be described later. The nut member 70 and the spindle member 60, which will be described later, may be disposed on an inner circumferential surface of the piston 50.

The piston 50 may advance and retreat through the spindle member 60 and the nut member 70 coupled to the spindle member 60, and through this, the piston 50 may press the inner pad plate 11 toward the disk D to perform braking. Unlike this, when a braking hydraulic pressure of the hydraulic pressure supply device 95 for braking is applied to the hydraulic chamber 33, the piston 50 advances toward the inner pad plate 11 and presses the inner pad plate 11, the caliper housing 30 operates in a direction opposite to the piston 50 by a reaction force, and the finger part 32 presses the outer pad plate 12 toward the disk D, thereby performing braking.

The rotational force of the actuator 90 is transmitted to the spindle member 60 through the power transmission device 80, whereby the spindle member 60 may be rotated in a first direction or a second direction. When the spindle member 60 is rotated in the first direction, the nut member 70 may be slid in a direction (left direction in FIG. 1) of advancing in the hydraulic chamber 33 to press the piston 50, and when the spindle member 60 is rotated in the second direction opposite to the first direction, the nut member 70 may be slid in a direction (right direction in FIG. 1) of retreating in the hydraulic chamber 33 to release the piston 50.

The caliper housing 30 may be provided with an oil port 34 through which a braking fluid such as a brake oil is introduced into the hydraulic chamber 33 of the cylinder 31 to apply a braking hydraulic pressure for braking, and the oil port 34 may be connected to the hydraulic supply device 95, which will be described later. A sealing member S may be provided between the piston 50 and the cylinder 31 to prevent leakage of the braking fluid. The sealing member S may be elastically deformed when the piston 50 advances during parking braking or stopping braking, and may prevent the retreat of the piston 50 with an elastic restoring force when the parking is released or the stopping is released.

The hydraulic supply device 95 may supply a braking fluid such as a brake oil into the hydraulic chamber 33 of the cylinder 31 of the caliper housing 30 or recover the braking fluid in the hydraulic chamber 33. That is, the hydraulic supply device 95 may supply a braking hydraulic pressure for performing braking into the hydraulic chamber 33 of the cylinder 31 or recover the braking hydraulic pressure in the hydraulic chamber 33.

As an example of the hydraulic supply device 95, a device capable of generating a braking hydraulic pressure by a hydraulic piston operated by an electrical signal output in response to a displacement of a brake pedal may be provided, but is not limited thereto. As another example of the hydraulic supply device 95, a master cylinder for discharging a pressurized medium (braking fluid) in response to a pressing force of the brake pedal may be provided, but is not limited thereto. The hydraulic supply device 95 may be connected to the hydraulic chamber 33 through the oil port 34 described above. The configuration of the hydraulic supply device 95 is not limited to the above, and various means for supplying a braking fluid into the hydraulic chamber 33 of the cylinder 31 of the caliper housing 30 or recovering the braking fluid in the hydraulic chamber 33 may be provided.

The hydraulic supply device 95 may increase a pressure inside the hydraulic chamber 33 by supplying the braking fluid into the hydraulic chamber 33 of the cylinder 31. In this case, the piston 50 is pressed by the braking hydraulic pressure inside the hydraulic chamber 33, so that the piston 50 may advance to press the inner pad plate 11. The hydraulic supply device 95 may also reduce the hydraulic pressure inside the hydraulic chamber 33 by recovering the braking fluid in the hydraulic chamber 33 of the cylinder 31. In this case, the braking hydraulic pressure inside the hydraulic chamber 33 is released, so that the piston 50 may retreat to release the inner pad plate 11. The hydraulic supply device 95 may increase or decrease the braking hydraulic pressure inside the hydraulic chamber 33 of the cylinder 31 by control of an electronic control unit (ECU) (not shown), which will be described later.

The spindle member 60 includes a spindle body 61, a spindle flange 62 formed to extend in a radial direction from the spindle body 61, and a spindle rod 63 having a second threaded portion formed on an outer circumferential surface thereof.

The spindle body 61 may be disposed to penetrate through the cylinder 31 of the caliper housing 30 to be dynamically connected to an output shaft 92a of a reducer 92 of the actuator 90 through the power transmission device 80, and the spindle flange 62 and the spindle rod 63 may be disposed inside the hydraulic chamber 33 of the cylinder 31. In order to stably support the spindle member 60, an O-ring 41 and a first bearing 42 may be provided in positions of being spaced apart from each other in the cylinder 31. The O-ring 41 may be provided between an outer circumferential surface of the spindle body 61 and the cylinder 31 to rotatably support the spindle body 61, and the first bearing 42 may be provided between the spindle flange 52 and the cylinder 31 to rotatably support the spindle flange 62. The O-ring 41 may be made of an elastic material such as rubber, and may seal between the outer circumferential surface of the spindle body 61 and the cylinder 31 to prevent the braking fluid or braking hydraulic pressure from leaking or releasing between the outer circumferential surface of the spindle body 61 and the cylinder 31.

The nut member 70 includes a head part 71 in contact with the piston 50, and a rod part 72 extending from the head part 71 and having a first threaded portion formed on an inner circumferential surface thereof to be screwed with the spindle member 60. The head part 71 and the rod part 72 may be provided integrally, and the rod part 72 may be provided in a cylindrical shape having a diameter smaller than that of the head part 71. The head part 71 is provided to be in contact with the piston 50 in the inside of the piston 50, and the rod part 72 is provided to form a space in which the braking fluid may be supplied between the outer circumferential surface thereof and the inner circumferential surface of the piston 50.

Although not shown, the head part 71 of the nut member 70 may have a plurality of slots (not shown) of a predetermined depth recessed along an outer circumferential surface of the head part 71. Therefore, the braking fluid may press the piston 50 by passing through the slot (not shown) of the head part 71.

The rod part 72 of the nut member 70 has a passing hole formed inside the rod part 72 along a longitudinal direction thereof to be screwed with the spindle rod 63 of the spindle member 60, and the first threaded portion formed of a female thread (or a male thread) is provided on an inner circumferential surface of the passing hole. Correspondingly, the second threaded portion formed of a male thread (or a female thread) may be provided on the outer circumferential surface of the spindle rod 63 to be engaged with the first threaded portion. Accordingly, as the nut member 70 advances as the spindle member 60 rotates in the first direction or retreats as the spindle member 60 rotates in the second direction (a direction opposite to the first direction), the nut member 70 may press or release the piston 50.

The actuator 90 may be composed of an actuator housing, a motor 91, and the reducer 92. The reducer 92 may reduce power provided from the motor 91 and transmit the power to the power transmission device 80 and may have various structures such as a planetary gear assembly. The motor 91 may be provided as a bidirectional motor, and the spindle member 60 may be rotated in the first direction or the second direction according to the rotation of the motor 91 in one direction or the other direction. The output shaft 92a of the reducer 92 of the actuator 90 may be connected to the input part 81 of the power transmission device 80.

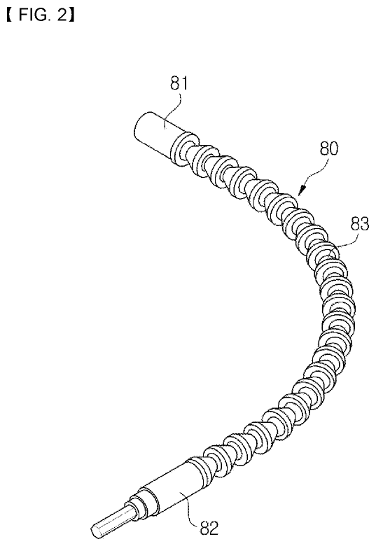

FIGS. 1 and 2 show a flexible shaft provided as an example of the power transmission device 80 of the disclosure.

The power transmission device 80 is provided to transmit the rotational force of the actuator 90 to the spindle member 60. The power transmission device 80 may include the input part 81, the output part 82, and a body part 83 to connect the input part 81 and the output part 82.

In more detail, the input part 81 of the power transmission device 80 may be connected to the actuator 90. That is, the input part 81 of the power transmission device 80 is connected to the output shaft 92a of the reducer 92 of the actuator 90, so that the power of the actuator 90 may be input to the power transmission device 80.

The output part 82 of the power transmission device 80 may be connected to the spindle member 60. That is, the output part 82 of the power transmission device 80 is connected to the spindle body 61 of the spindle member 60, so that the power of the actuator 90 input to the power transmission device 80 may be output to the spindle member 60.

As an example, the power transmission device 80 may be provided as a flexible shaft in which the body part 83 is made of a flexible (flexible property in which an object is bent by an external force) material. As the power transmission device 80 is made of a flexible material, an installation position of the actuator 90 may be free within a limited space of a vehicle. That is, as shown in FIG. 1, the actuator 90 may be installed separately from the caliper housing 30, but is not limited thereto, and may be installed on various positions within a limited space of a vehicle. Although not shown, as an example, the actuator 90 may be installed to be directly connected to a lower end of the caliper housing 31 in FIG. 1 (the downward direction in FIG. 1), and alternatively, the actuator 90 may be installed to be spaced from the lower end of the caliper housing 31 by a predetermined distance downward.

The power transmission device 80 is not limited to being provided as the flexible shaft, and may be provided as a mechanical connection member that transmits various types of power.

Although not shown, as an example, the power transmission device 80 may be provided as a universal joint (not shown) to transmit the power of the actuator 90 to the spindle member 60. Although not shown, as another example, the power transmission device 80 may be provided as a rod shaft (not shown) in which one end and the other end are connected to the actuator 90 and the spindle member 60, respectively. Alternatively, the power transmission device 80 may be provided as a plurality of bevel gear shafts (not shown) on which bevel gears are formed.

The power transmission device 80 is not limited to the above-described configuration, and may be provided with various means capable of allowing the actuator 90 to be installed to be separated or spaced apart from the caliper housing 30 in a limited space of a vehicle and transmitting the power of the actuator 90 to the spindle member 60 of the caliper housing 30.

Referring to FIGS. 1 and 2, the input part 81 of the power transmission device 80 may receive the rotational force of the actuator 90, and the rotational force may be transmitted to the output part 82 through the body part 83. The output part 82 may transmit the rotational force to the spindle member 60. Because the actuator 90 and the spindle member 60 are connected via the power transmission device 80, the actuator 90 may be disposed to be spaced apart from the caliper housing 30. In more detail, the spindle member 60 is disposed inside the cylinder 31 of the caliper housing 30, and the output shaft 92a of the actuator 90 may be disposed to be spaced apart from the spindle member 60.

In a conventional electronic caliper brake, an actuator is directly coupled to a caliper housing, and an output shaft of the actuator is directly connected to a spindle member without a separate member to transmit a rotational force. Because the conventional electronic caliper brake has a structure in which the caliper housing and the actuator are directly coupled, when the caliper housing and actuator are installed in a limited space inside a vehicle body, interference with other vehicle body structures such as a wheel of a vehicle and a knuckle may occur.

In the electronic caliper brake 100 according to the present embodiment, the actuator 90 and the spindle member 60 are connected via the power transmission device 80, and the rotational force of the actuator 90 may be transmitted to the spindle member 60 through the power transmission device 80. Accordingly, even when the caliper housing 30 and the actuator 90 are disposed to be spaced apart from each other, the rotational force of the actuator 90 may be transmitted to the spindle member 60 through the power transmission device 80.

In the electronic caliper brake 100 according to the present embodiment, because the caliper housing 30 and the actuator 90, specifically, the actuator housing may be separately disposed to be spaced apart from each other, it is easy to arrange the caliper housing 30 and the actuator 90 in a limited inner space of a vehicle so as not to interfere with other vehicle body parts. That is, it is easy to install the caliper housing 30 and the actuator 90 in a limited inner space of a vehicle.

In the electronic caliper brake 100 of the disclosure, because the caliper housing 30 and the actuator 90 are separately disposed to be spaced apart from each other, and a space between the caliper housing 30 and the actuator 90 may be connected by the flexible power transmission device 80, interference with other vehicle body structures may be avoided or prevented, and the rotational force of the actuator 90 may be effectively transmitted to the spindle member 60 through the power transmission device 80.

In the electronic caliper brake 100 according to the disclosure, the actuator 90 and the caliper housing 30 may be connected via the power transmission device 80.

Although not shown, as another embodiment of the disclosure, the electronic caliper brake 100 may have a structure in which a plurality of the caliper housings 30 is connected through one of the actuator 90. For example, the actuator 90 may be provided with a pair of the output shafts 92a, a pair of the power transmission devices 80 may be provided, the input parts 81 of the pair of power transmission devices 80 may be connected to the pair of output shafts 92a, respectively, and the output parts 82 may be connected to the spindle members 60 of the caliper housings 30 provided on left and right wheels of the vehicle, respectively. Unlike this, a pair of the output shafts 92a of the actuator 90 may be provided, a pair of the power transmission devices 80 may be provided, the input parts 81 of the pair of power transmission devices 80 may be connected to the pair of output shafts 92a, respectively, and the output parts 82 may be connected to the spindle members 60 of the caliper housings 30 provided on front and rear wheels of the vehicle, respectively.

That is, as one of the actuator 90 includes a plurality of the output shafts 92a, and the plurality of output shafts 92a is connected to a plurality of the corresponding power transmission devices 80 and a plurality of the corresponding caliper housings 90, respectively, even with only one of the actuator 90, power for braking may be provided to a plurality of the disks D. That is, even with only one of the actuator 90, power for braking may be provided to a left front wheel, right front wheel, left rear wheel, or right rear wheel of a vehicle.

The electronic caliper brake 100 according to the present embodiment may further include an electronic control unit (ECU) (not shown). The electronic control unit (not shown) may control the operation of the hydraulic supply device 95 and the actuator 90. The electronic control unit (ECU) (not shown) according to an exemplary embodiment of the disclosure may be implemented through an algorithm configured to control the operation of various components or a non-volatile memory (not shown) configured to store data relating to software instructions for reproducing the algorithm, and a processor (not shown) configured to perform operations described below using data stored in the memory. The memory and the processor may be implemented as separate chips. Alternatively, the memory and the processor may be implemented as a single chip integrated with each other. The processor may have the form of one or more processors.

Hereinafter, an operation method of the electronic caliper brake according to the present embodiment will be described with reference to FIGS. 1 to 5.

A first mode is a mode for performing parking braking of the vehicle.

In the first mode, the electronic control unit (ECU) (not shown) may control the hydraulic supply device 95 to generate a braking hydraulic pressure to advance the piston 50, control the spindle member 60 to rotate in the first direction by operating the actuator 90 so that the piston 50 is supported in the advanced position, and then control the nut member 70 to advance according to the rotation of the spindle member 60 in the first direction to support the piston 50.

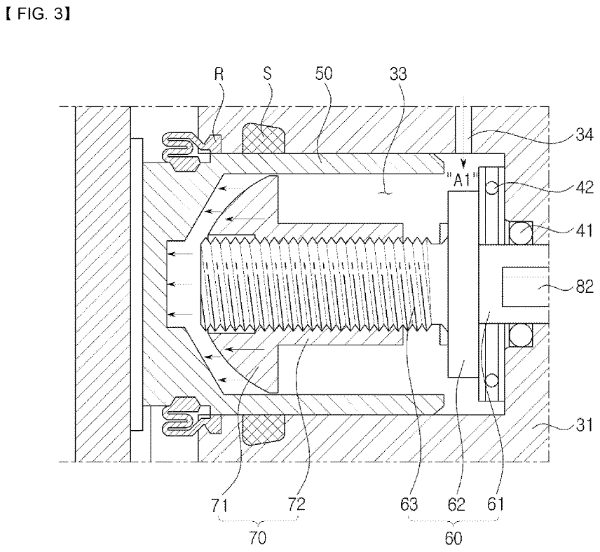

The electronic control unit (ECU) (not shown) may control the hydraulic supply device 95 to generate a braking hydraulic pressure. That is, the braking fluid supplied by the hydraulic supply device 95 may be introduced into the hydraulic chamber 33 of the cylinder 31 through the oil port 34 (direction “A1” in FIG. 3). The braking fluid is introduced into the hydraulic chamber 33 of the cylinder 31 to increase an inner pressure thereof, so that the piston 50 may advance in a direction of pressing the inner pad plate 11 (left direction in FIG. 3). Accordingly, the inner pad plate 11 presses the disk D.

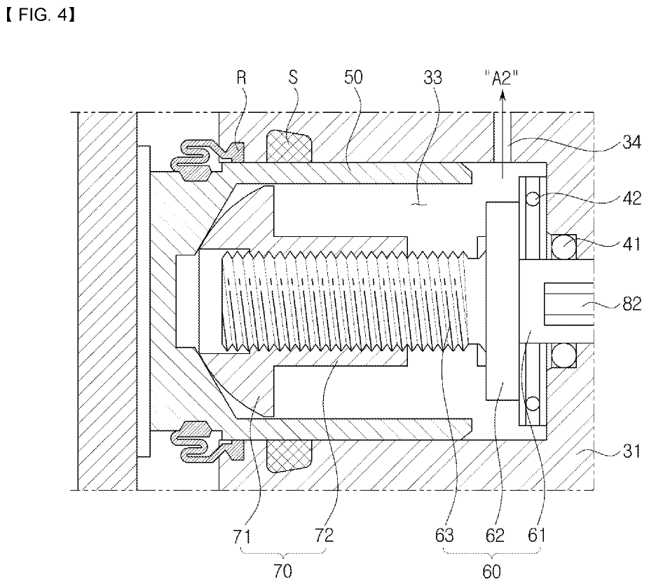

Thereafter, the electronic control unit (ECU) (not shown) may operate the actuator 90 so that the piston 50 is supported in the advanced position. The spindle member 60 may be rotated in the first direction (direction in which the nut member advances) by the operation of the actuator 90. Accordingly, as shown in FIG. 4, the nut member 70 advances by the rotation of the spindle member 60 in the first direction so that a front surface of the head part 71 of the nut member 70 may support a front portion of the inner circumferential surface of the piston 50.

Thereafter, the electronic control unit (ECU) (not shown) may control the hydraulic supply device 95 to release the braking hydraulic pressure so that the inner pressure of the hydraulic chamber 33 of the cylinder 31 decreases. That is, the hydraulic supply device 95 may recover the braking fluid supplied to the hydraulic chamber 33 (direction “A2” in FIG. 4). As the braking fluid is recovered to the hydraulic supply device 95, the inner pressure of the hydraulic chamber 33 of the cylinder 31 decreases, but the nut member 70 supports the piston 50, so that the piston 50 may be prevented from retreating. According to the present embodiment, after the piston 50 advances using the hydraulic supply device 95 to perform the parking braking, the nut member 60 may advance to support the piston 50 in the advanced position. Accordingly, because it is sufficient that the actuator 90 provides power for only advancing the nut member 60, the parking braking may be performed even in the case of the actuator 90 using the motor 91 having a relatively small output.

A second mode is a mode for releasing the parking braking of a vehicle.

In the second mode, the electronic control unit (ECU) (not shown) may control the hydraulic supply device 95 to generate an additional braking hydraulic pressure so that a gap is formed between the piston 50 and the nut member 70, control the actuator 90 to operate to rotate the spindle member 60 in the second direction opposite to the first direction, and then control the nut member 70 according to the rotation of the spindle member 60 in the second direction to retreat to be spaced apart from the piston 50.

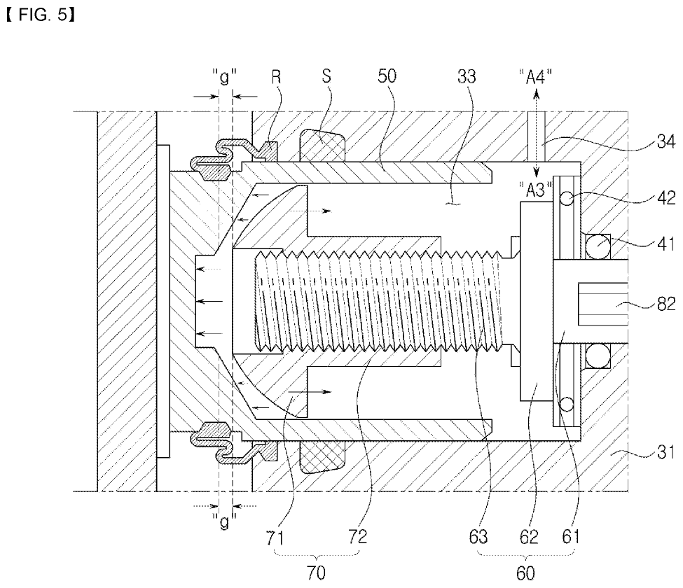

Referring to FIG. 5, the electronic control unit (ECU) (not shown) may control the hydraulic supply device 95 to generate an additional braking hydraulic pressure. That is, the braking fluid supplied by the hydraulic supply device 95 may be introduced into the hydraulic chamber 33 of the cylinder 31 through the oil port 34 (direction “A3” in FIG. 5). In this case, it is appropriate that an amount of the braking fluid introduced into the hydraulic chamber 33 of the cylinder 31 is equal to or greater than that in the case of the first mode for performing parking braking, but is not limited thereto.

As the braking fluid is introduced into the hydraulic chamber 33 of the cylinder 31 to increase the inner pressure, the piston 50 advances by a predetermined distance (left direction in FIG. 5) by the braking hydraulic pressure, so that a gap (reference numeral “g”) may be formed between the piston 50 and the nut member 70.

Thereafter, the electronic control unit (ECU) (not shown) may operate the actuator 90 so that the nut member 70 retreats. The spindle member 60 may be controlled to rotate in the second direction (direction opposite to the first direction) by the operation of the actuator 90, and the nut member 70 may be controlled to retreat in the second direction to be spaced apart from the piston 50 by the rotation of the spindle member 60.

Thereafter, the electronic control unit (ECU) (not shown) may control the hydraulic supply device 95 to release the braking hydraulic pressure so that the inner pressure of the hydraulic chamber 33 of the cylinder 31 decreases. That is, the hydraulic supply device 95 may recover the braking fluid supplied to the hydraulic chamber 33 (direction “A4” in FIG. 5). Because the braking fluid is recovered by the hydraulic supply device 95 and the inner pressure of the hydraulic chamber 33 of the cylinder 31 decreases, the piston 50 may retreat (right direction in FIG. 5). Accordingly, the pressing of the inner pad plate 11 to the disk D may be released.

When the nut member retreats without forming a gap between the piston and the nut member, the nut member may not retreat smoothly due to an engaging force acting between the piston and the nut member, and in order for the nut member to retreat, an actuator equipped with a high-power motor may be required.

However, according to the present embodiment, in order to release the parking braking, the piston 50 advances using the hydraulic supply device 95 so that the gap g is formed between the piston 50 and the nut member 60, and then the nut member 60 may retreat. Accordingly, because the actuator 90 only needs to provide power for the nut member 60 to retreat, even when the actuator 90 uses the motor 91 having a relatively small output, the parking braking may be released.

As is apparent from the above, according to an electronic caliper brake and an operation method thereof by the present embodiment, a caliper housing and an actuator can be disposed to be separated or spaced apart from each other.

According to the electronic caliper brake and the operation method thereof by the present embodiment, because parking braking is performed through a braking hydraulic pressure of brake oil or the like and a mechanical force of the actuator, reliability of parking braking can be secured.

According to the electronic caliper brake and the operation method thereof by the present embodiment, because a braking hydraulic pressure of brake oil or the like is uses, the parking braking can be performed with a small braking force of the actuator, and thus the actuator can be miniaturized.

According to the electronic caliper brake by the present embodiment, because the actuator is disposed to be separated from the caliper housing, sagging of the caliper housing can be prevented.

According to the electronic caliper brake by the present embodiment, because sagging of the caliper housing is prevented, sliding of the housing during the parking braking or stopping braking can be improved to improve drag, and occurrence of uneven wear of a brake pad can be prevented.

While the disclosure has been particularly described with reference to exemplary embodiments, it should be understood by those of skilled in the art that various changes in form and details may be made without departing from the spirit and scope of the disclosure.

What is claimed is:

1. An electronic caliper brake comprising:
a carrier on which a pair of pad plates are installed to advance and retreat;
a caliper housing slidably installed on the carrier and provided with a cylinder in which a piston is installed to advance and retreat by a braking hydraulic pressure;
a hydraulic pressure supply device configured to supply the braking hydraulic pressure to the cylinder;
an actuator configured to provide a rotational force;
a spindle member installed to penetrate through a rear portion of the cylinder and configured to rotate by receiving the rotational force of the actuator;
a nut member configured to advance and retreat depending to the rotation of the spindle member to press and release the piston; and
a power transmission device in which an input part is connected to an output shaft of the actuator and an output part is connected to the spindle member, and configured to transmit the rotational force of the actuator to the spindle member,
wherein the output shaft of the actuator is disposed to be spaced apart from the spindle member.

2. The electronic caliper brake according to claim 1, wherein
the power transmission device is provided as one of a flexible shaft and a universal joint.

3. The electronic caliper brake according to claim 1, wherein
the power transmission device is provided as one of a rod shaft and a plurality of bevel gear shafts.

4. The electronic caliper brake according to claim 1, wherein
the spindle member is disposed inside the cylinder of the caliper housing.

5. The electronic caliper brake according to claim 1, wherein
the actuator is provided with a pair of the output shafts,
a pair of the power transmission devices are provided, and
the input parts of the pair of power transmission devices are connected to the pair of output shafts, respectively, and the output parts are connected to the spindle members of the caliper housings provided on left and right wheels of a vehicle, respectively.

6. The electronic caliper brake according to claim 1, wherein
the actuator is provided with a pair of the output shafts,
a pair of the power transmission devices are provided, and
the input parts of the pair of power transmission devices are connected to the pair of output shafts, respectively, and the output parts are connected to the spindle members of the caliper housings provided on front and rear wheels of a vehicle, respectively.

7. The electronic caliper brake according to claim 1, further comprising:
an electronic control unit configured to control the operation of the hydraulic supply device and the actuator.

8. An electronic caliper brake comprising:
a carrier on which a pair of pad plates are installed to advance and retreat;
a caliper housing slidably installed on the carrier and provided with a cylinder in which a piston is installed to advance and retreat by a braking hydraulic pressure;
a hydraulic pressure supply device configured to supply the braking hydraulic pressure to the cylinder;
an actuator configured to provide a rotational force;
a spindle member installed to penetrate through a rear portion of the cylinder and configured to rotate by receiving the rotational force of the actuator;
a nut member configured to advance and retreat depending to the rotation of the spindle member to press and release the piston; and
a power transmission device in which an input part is connected to an output shaft of the actuator and an output part is connected to the spindle member, and configured to transmit the rotational force of the actuator to the spindle member,
wherein the power transmission device is provided to be flexible.

9. An electronic caliper brake comprising:
a carrier on which a pair of pad plates are installed to advance and retreat;
a caliper housing slidably installed on the carrier and provided with a cylinder in which a piston is installed to advance and retreat by a braking hydraulic pressure;
a hydraulic pressure supply device configured to supply the braking hydraulic pressure to the cylinder;
an actuator configured to provide a rotational force and comprising an actuator housing;
a spindle member installed to penetrate through a rear portion of the cylinder and configured to rotate by receiving the rotational force of the actuator;
a nut member configured to advance and retreat depending to the rotation of the spindle member to press and release the piston; and
a power transmission device in which an input part is connected to an output shaft of the actuator and an output part is connected to the spindle member, and configured to transmit the rotational force of the actuator to the spindle member,
wherein the caliper housing and the actuator housing are separately provided to be spaced apart from each other.

10. An operation method of the electronic caliper brake according to claim 7, wherein
in a first mode in which parking braking is performed,
the electronic control unit controls:
the hydraulic supply device to generate a braking hydraulic pressure to advance the piston;
the spindle member to rotate in a first direction by operating the actuator so that the piston is supported in an advanced position; and
the nut member to advance according to the rotation of the spindle member in the first direction to support the piston.

11. The operation method according to claim 10, wherein
the electronic control unit controls the hydraulic pressure supply device such that the braking hydraulic pressure is released in a state in which the piston is supported by the nut member.

12. The operation method according to claim 10, wherein
in a second mode in which release of the parking braking is performed,
the electronic control unit controls:
the hydraulic supply device to generate an additional braking hydraulic pressure so that a gap is formed between the piston and the nut member;
the actuator to operate to rotate the spindle member in a second direction opposite to the first direction; and
the nut member to retreat according to the rotation of the spindle member in the second direction to be spaced apart from the piston.

13. The operation method according to claim 12, wherein
the electronic control unit controls the hydraulic pressure supply device such that the braking hydraulic pressure is released in a state in which the nut member is spaced apart from the piston.
